(19) United States
(12) Patent Application Publication
(10) Pub. No.: US 2011/0024987 A1
(43) Pub. Date: Feb. 3, 2011

(54) MECHANICAL SEAL ASSEMBLY FOR A ROTATABLE SHAFT

(75) Inventor: Daniel Theodore Crowley, Owatonna, MN (US)

Correspondence Address: FOGG & POWERS LLC, 5810 W 78TH STREET, SUITE 100, MINNEAPOLIS, MN, 55439, US

(73) Assignee: Sputtering Components, Inc., Owatonna, MN (US)

(21) Appl. No.: 12/533,277

(22) Filed: Jul. 31, 2009

(51) Int. Cl. F16J 15/34

(52) U.S. Cl. 277/306; 277/361

(57) ABSTRACT

A mechanical seal assembly for a rotatable shaft is disclosed. In one embodiment, the mechanical seal assembly comprises a first sealing element configured to surround a rotatable shaft, the first sealing element including an annular plate, and a plurality of annular rings that protrude from the annular plate in a direction substantially parallel to the rotatable shaft. The annular rings are concentric with the rotatable shaft. A second sealing element is configured to surround the rotatable shaft, with the second sealing element including one or more springs that provide a biasing force against the first sealing element such that substantially constant contact is maintained between the annular rings and a sealing surface. One or more lubricant cavities are defined between the annular rings and the sealing surface.

### BACKGROUND

There are two main types of sealing methods that are currently used for providing seals around rotating shafts such as rotary sputter cathodes. These include lip seals and mechanical face seals.

In a typical lip seal arrangement, a rotating metal shaft is surrounded by a stationary, concentric seal housing. This seal housing normally contains bores, grooves, or the like, which retain an annular seal of an elastomeric material. This elastomeric seal will bridge the gap between the seal housing and the rotating shaft, and contact the rotating shaft around its exterior diameter, exerting a sealing force perpendicular to both the shaft's axis and direction of rotation. The area of contact is kept to a minimum so as not to cause unnecessary friction on the system. Nevertheless, enough friction is required to prevent deformation of the seal by water, air, or other medium that is exerting pressure on the side of the sealing element in a shearing fashion. Typical systems utilize a cylindrical metal shaft, and one or more lip seals disposed down the length of the shaft.

While lip seals are relatively simple in design and inexpensive to implement, lip seals suffer from several serious drawbacks. First, the elastomeric material may wear a groove into the metal shaft. In this scenario, the contact between the shaft and the sealing element may be reduced to a point where the water pressure can now force deformation of the seal and result in seal failure. Additionally, once a groove has been worn into a shaft, replacement seals will wear out faster. Lip seals also require a tight alignment tolerance between the rotating shaft and the seal housing. Down time and replacement of shafts can be costly.

Lip seals are particularly unsuitable for situations with a high pressure differential on opposite sides of the seal. In these situations, the high pressure differential will result in faster wear of the seal and/or shaft. The higher the pressure differential, the shorter the life of the seal and the more severe the damage to the rotating shaft.

Furthermore, lip seals are particularly unsuitable in situations with abrasive content or debris in the medium that they are sealing. Debris can become lodged between the lip seal and the shaft, resulting in either immediate seal failure, or accelerated wear of the seal or the shaft.

Lastly, lip seals are most appropriately used with sealing oil or some fluid that lubricates the rubber against the shaft. In a situation where water is to be sealed, lip seals may fail even when the seals are greased, as the grease is easily washed away from the contact point. The grease cannot be easily replaced in situ and rapid seal wear results, as the water alone is not a sufficient lubricant. Lip seals cannot be run in a dry environment without overheating and destroying the seal contact area, causing immediate failure.

Mechanical face seals, in contrast to lip seals, form a seal between two parallel planar surfaces, both perpendicular to the axis of rotation of the shaft. The face seal is maintained by the application of force, typically by a mechanical spring, between the two planes in a direction parallel to the shaft's axis of rotation. In the typical face seal application, relatively larger contact areas are used between the two sealing surfaces. As such, it is particularly important that the materials are hard and smooth on the mating faces, and have a low coefficient of friction between them. In a typical arrangement, one surface is made of silicon or tungsten carbide, and the other of a hard smooth ceramic.

Mechanical face seals have the advantage of sealing fluids that would not effectively lubricate a lip seal, such as water. Such face seals also have potentially longer life than lip seals, as face seals do not wear the rotating shaft or the seal housing. In addition, face seals in general withstand higher pressure differentials across the seal than lip seals. Despite their higher sealing surface area, appropriate material selection for face seals results in lower overall friction than lip seals.

Nevertheless, mechanical face seals also have several disadvantages. First, although they can operate in environments such as water, mechanical face seals cannot run in the absence of the fluid that they are sealing or they will very quickly overheat and be destroyed. In addition, face seals are more expensive and much more complicated than lip seals. Face seals generally use more exotic materials and are more expensive to fabricate.

Moreover, mechanical face seals fail in some applications because they are designed to operate by allowing some of the medium (or fluid) to be sealed to pass thru the seal to lubricate the contact surface area. Some media such as slurries, plastics, latex, and other high viscosity fluids are particularly unsuitable for operation in this manner as they would cause either abrasive seal wear, or harden between the sealing surfaces resulting in deformation and non-contact of the surfaces.

In a rotary sputter cathode, neither of the traditional approaches of a lip seal or a mechanical face seal is suitable. In this situation, rotary seals must operate to seal water against either an ambient air pressure or a high vacuum environment. Accordingly, the seal must be able to operate with a differential pressure ranging from as low as −15 psi to potentially as high as 150 psi. It is also necessary to provide a rotary seal between ambient air and vacuum. This air to vacuum seal operates against a maximum of 15 psi. In many sputtering systems there are multiple rotating sputter cathodes, so the reliability of the rotary seals for both vacuum and for water become very important. In most system designs, a water seal leak will cause a limited disturbance to a manufacturing process, resulting from a shutdown of one of the many cathodes. However, if one rotary air to vacuum seal fails, the integrity of the entire vacuum chamber is compromised and the entire sputtering process needs to be shut down. This is extremely costly and time consuming to the sputtering plant.

Failure of a lip seal in a water based environment can be caused by rotary shaft misalignment, dirty water, and the ineffectiveness of water as a lubricant in a lip seal. Lip seals in rotary cathodes cannot be used without cooling water flowing thru the cathode. In many cases, rotary cathodes need to be run/tested off-line with no water flow. This can only be done momentarily without water flow due to the heat build up from friction at the lip seal, which will quickly destroy the seal.

Lip seals also require a tight alignment tolerance between the rotating shaft and the seal housing. This is a common problem with rotary sputter cathodes due to the difficulty with alignments between a rotating shaft's end supports. There are also problems getting straight shaft material between the end supports, and this shaft material also sags because of the need for this shaft to span long distances. This causes further misalignment problems.

In addition, lip seals were not intended to seal water or air in a rotary application for very long without constant and proper lubrication. Water is not a lubricant for these seals and it is very difficult to maintain lubrication on these seals in water. Packing the lip seals with the proper water resistant grease helps, but not for long. Also, lip seals that are exposed to high water pressures in a rotary application will experience rapid lip wear. This is exacerbated by shaft misalignments and lack of proper lubrication.

Mechanical face seals are used in rotary sputter cathodes for rotationally sealing the cooling water as they are often more reliable than lip seals in a water based environment. While mechanical face seals solve some of the problems with rotational water sealing, these face seals still have some drawbacks. For example, face seals cannot be used as a rotational air or vacuum seal. Face seals use the medium to be sealed as the lubricant on the faces of the seal, and also to cool the seal, because of the extreme heat this seal produces at the contact surface. The face seal allows a very small amount of the medium being sealed thru the seal for cooling the seal. This sort of leak is unacceptable in a sputtering system, as the bit of air or water being allowed into the system would result in significant process disruption.

Accordingly, there is a need for improved seals that overcome the foregoing problems for rotatable shafts such as rotary sputter cathodes.

### SUMMARY

The present invention relates to a mechanical seal assembly for a rotatable shaft such as used in a rotary sputter cathode. In one embodiment, the mechanical seal assembly comprises a first sealing element configured to surround a rotatable shaft, the first sealing element including an annular plate, and a plurality of annular rings that protrude from the annular plate in a direction substantially parallel to the rotatable shaft. The annular rings are concentric with the rotatable shaft. A second sealing element is configured to surround the rotatable shaft, with the second sealing element including one or more springs that provide a biasing force against the first sealing element such that substantially constant contact is maintained between the annular rings and a sealing surface. One or more lubricant cavities are defined between the annular rings and the sealing surface.

### BRIEF DESCRIPTION OF THE DRAWINGS

Features of the present invention will become apparent to those skilled in the art from the following description with reference to the drawings. Understanding that the drawings depict only exemplary embodiments of the invention and are not therefore to be considered limiting in scope, the invention will be described with additional specificity and detail through the use of the accompanying drawings, in which:

FIG. 1A is an end view of a mechanical seal assembly according to one embodiment;

FIG. 1B is a cross-sectional side view of the mechanical seal assembly of FIG. 1A;

FIG. 2A is an end view of a mechanical seal assembly according to another embodiment;

FIG. 2B is a cross-sectional side view of the mechanical seal assembly of FIG. 2A;

FIG. 3A is an end view of a mechanical seal assembly according to a further embodiment;

FIG. 3B is a cross-sectional side view of the mechanical seal assembly of FIG. 3A;

FIG. 4A is an end view of a mechanical seal assembly according to an alternative embodiment;

FIG. 4B is a cross-sectional side view of the mechanical seal assembly of FIG. 4A;

FIG. 5A is a plan view of an annular plate for a mechanical seal assembly according to one embodiment;

FIG. 5B is a cross-sectional side view of the annular plate of FIG. 5A; and

FIGS. 6A-6C illustrate alternative ring geometries for the annular rings of an annular plate of a mechanical seal assembly.

### DETAILED DESCRIPTION

In the following detailed description, embodiments are described in sufficient detail to enable those skilled in the art to practice the invention. It is to be understood that other embodiments may be utilized without departing from the scope of the present invention. The following description is, therefore, not to be taken in a limiting sense.

The present invention relates to a mechanical seal assembly for use in sealing rotatable shafts, such as those used in rotary sputter cathodes. The various embodiments of the mechanical seal assembly provide sealing for a rotating shaft such that one medium is prevented from contacting another medium. These mechanical seal assemblies can operate in the presence of abrasive or highly viscous fluids without damage to the rotating shaft or seal housing. The mechanical seal assemblies can also operate dry, such as without the presence of a substance to be sealed, without overheating or failure of the seal.

The mechanical seal assemblies generally include a series of annular rings that protrude from an annular plate, which is either in intimate attachment to or integral with a rotatable shaft, with the annular rings being concentric with the rotatable shaft. The annular rings protrude from the annular plate in a direction parallel to the rotatable shaft and make contact with a sealing surface that is in a plane perpendicular to a rotational axis and direction of rotation of the shaft. Constant contact is maintained between the annular rings and the sealing surface by mechanical springs, and is further aided by the pressure of the substance to be sealed.

The materials for the annular rings and sealing surface are selected such that the coefficient of friction between them is minimized, and wear resistant characteristics are maximized. Suitable materials for the annular rings and sealing surface include stainless steel (for rings), and UHMW (ultra high molecular weight) plastic for the sealing surface.

The present mechanical seal assemblies have a low resistance or drag on the rotating system such as a rotary sputter cathode. The mechanical seal assemblies extend the reliability of rotary sputter cathodes, and eliminate the need for pumping ports, tubing, hoses, gauging, and pumps used for pumping on the back side of conventional rotary vacuum lip seals.

The mechanical seal assembly of the invention will be described in further detail as follows with reference to the drawings.

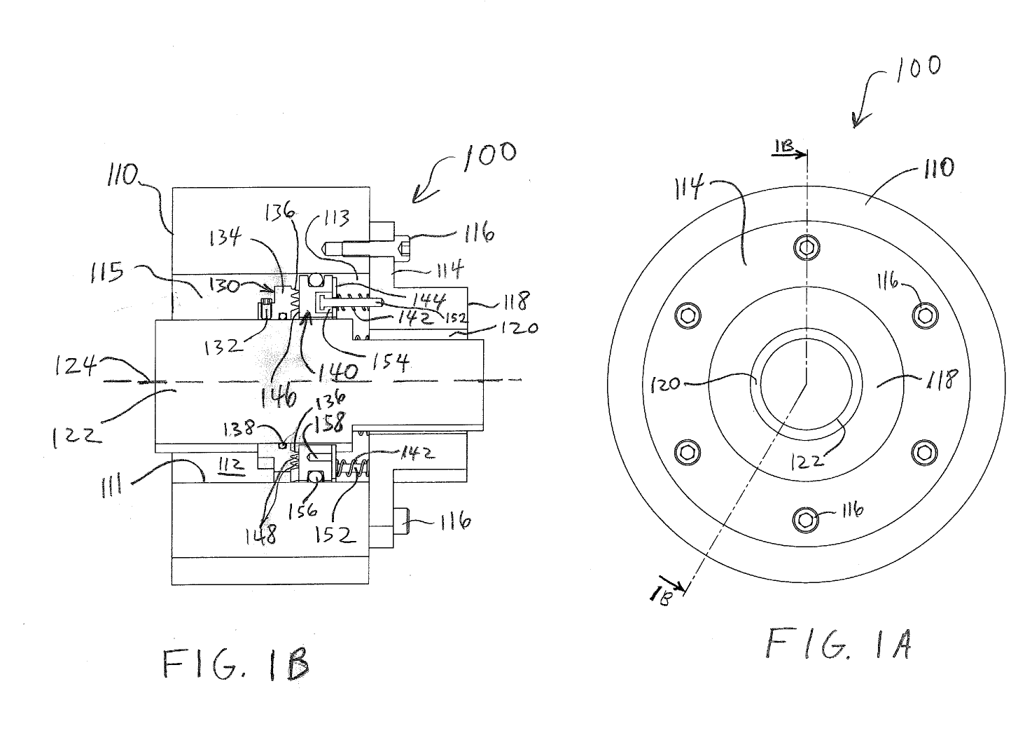

FIGS. 1A and 1B illustrate a mechanical seal assembly 100 for a rotating shaft, such as in a rotary sputter cathode, according to one embodiment. The mechanical seal assembly 100 provides sealing between two media in the presence of a rotating shaft. Exemplary media include a substantial vacuum, a gas, a liquid, an abrasive slurry, or a viscous liquid.

The mechanical seal assembly 100 includes a seal housing 110 having an interior surface 111 that defines a passageway 112. A seal end plate 114 can be affixed to housing 110 such as by mounting bolts 116. The seal end plate 114 has an outer flange portion 118 with not needed in text or drawing a passageway 120 in communication with passageway 112. A rotatable shaft 122 extends through passageways 112 and 120 and rotates around a central axis 124. The passageway 112 has a first compartment 113 that contains a first medium at higher pressure (to be sealed) and a second compartment 115 that contains a second medium.

In an alternative embodiment, the seal end plate can be an integral part of the seal housing, with an opening in the housing provided as needed for a rotatable shaft to pass thru the housing.

A first sealing element 130 surrounds rotatable shaft 122 inside housing 110 and is mounted to shaft 122 so that sealing element 130 rotates with shaft 122. The sealing element 130 can be affixed to rotatable shaft 122 with a set screw 132 or the like. The sealing element 130 includes an annular plate 134, and a plurality of annular rings 136 protruding from annular plate 134 in a direction substantially parallel to rotatable shaft 122. The annular rings 136 are concentric with rotatable shaft 122 and can have various cross-sectional profile geometries as discussed further hereafter. The annular plate 134 has an annular groove located along an interior surface thereof that holds a first sealing member 138 such as an o-ring against a portion of rotatable shaft 122. The sealing member 138 rotates with shaft 122.

A second sealing element 140 surrounds rotatable shaft 122 inside housing 110 and is stationary with respect to shaft 122 and first sealing element 130. The second sealing element 140 is biased against first sealing element 130 and engages with annular plate 134 at each of the annular rings 136. In one embodiment, sealing element 140 is kept in substantially constant contact with sealing element 130 by the force applied by one or more mechanical springs 142 through a pressure plate 144.

One or more lubricant cavities 148 are defined between a sealing surface 146 of sealing element 140 and annular rings 136. The lubricant cavities 148 are filled with grease during installation of seal assembly 100. The grease provides hydraulic pressure that resists sealing element wear, acts as a constant lubricant on annular rings 136 as the sealing element wears, and acts as a further barrier to debris and the medium being sealed. Through the application of force by springs 142, constant pressure is maintained between sealing surface 146 and both the annular rings 136 and lubricant cavities 148.

One or more anti-rotation pins 152 surround rotatable shaft 122 and can hold a corresponding number of springs 142 in place. The pins 152 are affixed to seal end plate 114 and prevent sealing element 140 from rotating with sealing element 130. The pins 152 protrude into corresponding locating cavities 154 in sealing element 140. The pins 152 also prevent sealing element 140 from moving more than a minimal distance away from sealing element 130 in the event that the pressure of the second medium in compartment 115 overcomes the force of spring 142. Threaded holes 158 are located in second sealing element 140 at multiple points between the locating cavities 154 to allow for easy removal of sealing element 140.

The second sealing element 140 has an annular groove located along an exterior surface thereof that holds a second sealing member 156 such as an o-ring against a portion of interior surface 111 of housing 110. The first and second compartments 113, 115 are sealingly separated from each other by the first and second sealing elements 130, 140. In particular, leakage of the first medium in compartment 113 to the second medium in compartment 115 is prevented via static sealing members 138 and 156 such as o-rings.

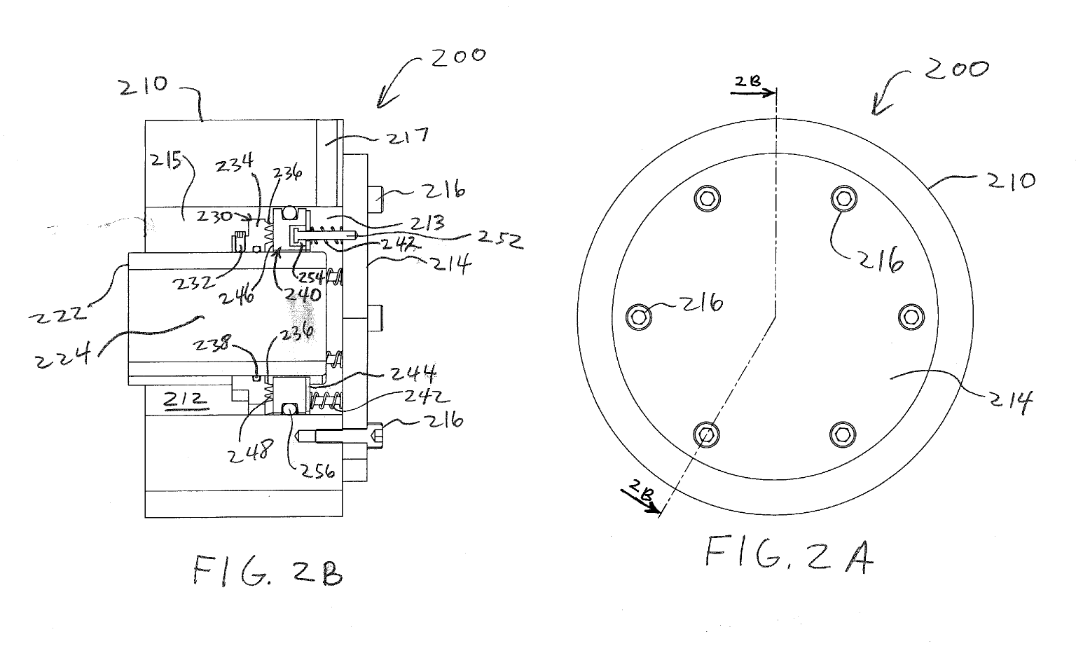

FIGS. 2A and 2B illustrate a mechanical seal assembly 200 for a rotating shaft, such as in a rotary sputter cathode, according to another embodiment, which includes many of the same features as mechanical seal assembly 100. The mechanical seal assembly 200 provides sealing between two media in the presence of a rotating shaft.

The mechanical seal assembly 200 includes a seal housing 210 defining a passageway 212 having a first compartment 213 that contains a first medium such as water, and a second compartment 215 that contains a second medium. The housing 210 also has a feed thru channel 217, which provides fluid communication with compartment 213 to outside of the housing 210. A seal end plate 214 is affixed to housing 210, such as by mounting bolts 216, and covers passageway 212. A rotatable hollow shaft 222 extends into passageway 212 and includes a channel 224 in communication with compartment 213.

A first sealing element 230 surrounds rotatable shaft 222 inside housing 210 and is mounted to shaft 222 so that sealing element 230 rotates with shaft 222. The sealing element 230 can be affixed to shaft 222 with a set screw 232 or the like. The sealing element 230 includes an annular plate 234 with a plurality of annular rings 236. The sealing element 230 also has an o-ring 238 that rotates with shaft 222.

A second sealing element 240 surrounds rotatable shaft 222 inside housing 210 and is stationary with respect to shaft 222 and first sealing element 230. The second sealing element 240 is biased against first sealing element 230 and engages with annular plate 234 at each of the annular rings 236. The sealing element 240 is kept in constant contact with sealing element 230 by the force applied by one or more mechanical springs 242 through a pressure plate 244. One or more lubricant cavities 248, which can be filled with grease, are defined between a sealing surface 246 of sealing element 240 and annular rings 236.

One or more anti-rotation pins 252 serve to prevent sealing element 240 from rotating and can hold springs 242 in place, with the pins 252 protruding into corresponding locating cavities 254 in sealing element 240. The pins 252 also prevent sealing element 240 from moving more than a minimal distance away from sealing element 230 in the event that the pressure of the second medium in compartment 215 overcomes the force of spring 242. The pins 252 are affixed to seal end plate 214.

Leakage of the first medium in compartment 213 to the second medium in compartment 215 is prevented via static sealing members 238 and 256 such as o-rings.

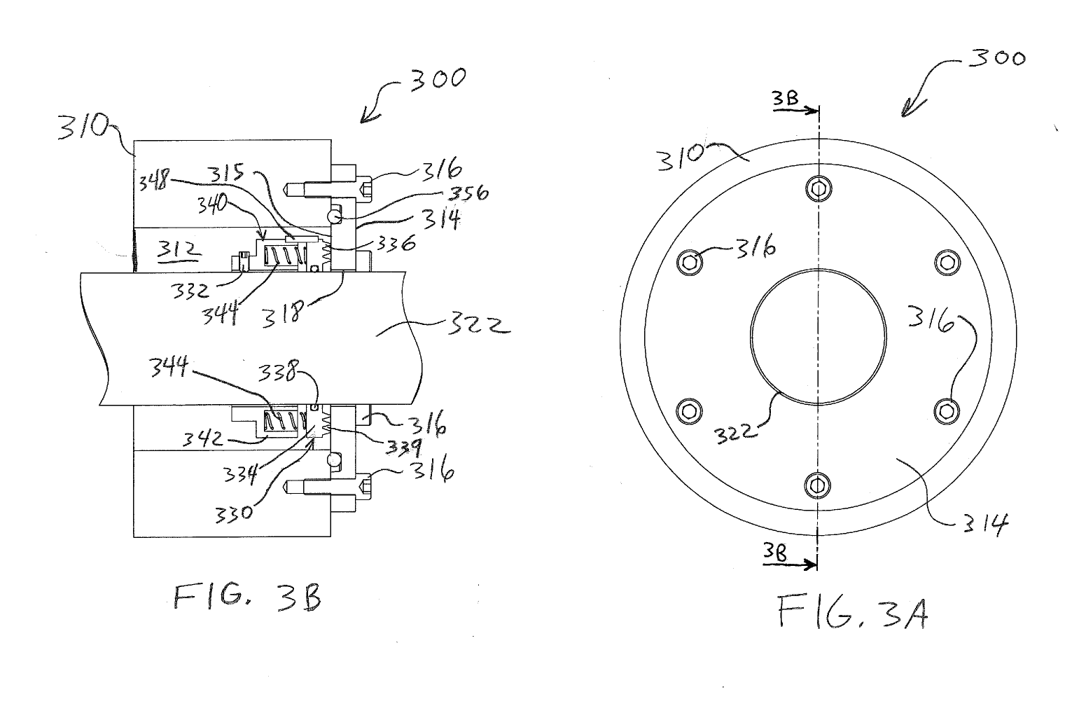

FIGS. 3A and 3B illustrate a mechanical seal assembly 300 for a rotating shaft, such as in a rotary sputter cathode, according to a further embodiment. The mechanical seal assembly 300 includes a seal housing 310 defining a passageway 312 that can contain a first medium. A seal end plate 314, such as a UHMW plastic seal plate, is affixed to seal housing 310 such as by mounting bolts 316. The end plate 314 has an inner sealing surface 315 that faces passageway 312, and a central aperture 318. A rotatable shaft 322 extends through passageway 312 and aperture 318.

A first sealing element 330 surrounds rotatable shaft 322 inside housing 310 and includes an annular plate 334 with a plurality of annular rings 336. The sealing element 330 also has an o-ring 338 that rotates with shaft 322. One or more lubricant cavities 339, which can be filled with grease, are defined between surface sealing 315 of end plate 314 and annular rings 336.

A second sealing element 340 surrounds rotatable shaft 322 inside housing 310 and is mounted to shaft 322 so that sealing element 340 rotates with shaft 322. The sealing element 340 can be affixed to shaft 322 with a set screw 332 or the like. The second sealing element 340 includes a plurality of spring holders 342 that each holds a spring 344 that is biased against first sealing element 330. Alternatively, a single spring holder and spring can be used in sealing element 340. The spring 344 applies a force to sealing element 330 so that annular rings 336 are kept in constant contact with sealing surface 315 of end plate 314. The sealing element 330 is connected to sealing element 340 by connector pins 348, such that sealing element 330 is prevented from rotating on its own. This allows sealing element 330 to rotate with shaft 322 while being axially movable. The pins 348 are affixed to sealing element 340.

Leakage of the first medium from passageway 312 through aperture 318 is prevented via o-ring 338. An o-ring 356 provides a seal between end plate 314 and housing 310 to also prevent leakage of the first medium from passageway 312.

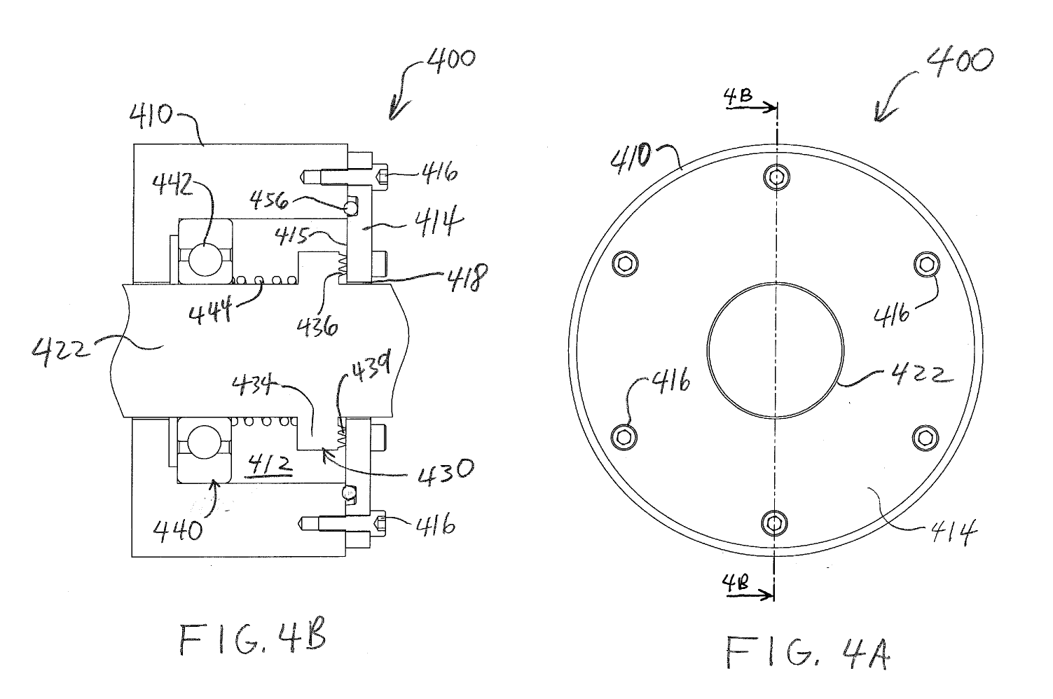

FIGS. 4A and 4B illustrate a mechanical seal assembly 400 according to an alternative embodiment, which includes some of the same features as mechanical seal assembly 300. The mechanical seal assembly 400 includes a seal housing 410 defining a passageway 412 that can contain a first medium. A seal end plate 414 can be affixed to housing 410 such as by mounting bolts 416. The end plate 414 has an inner sealing surface 415 and a central aperture 418. A rotatable shaft 422 extends through passageway 412 and aperture 418.

A first sealing element 430 is integrally formed around rotatable shaft 422 and includes an annular plate 434 with a plurality of annular rings 436. One or more lubricant cavities 439, which can be filled with grease, are defined between sealing surface 415 of end plate 414 and annular rings 436.

A second sealing element 440 surrounds rotatable shaft 422 inside housing 410. The second sealing element 440 includes a bearing component 442, and a spring 444 that is biased against first sealing element 430. The bearing component 442 is fitted around shaft 422 to allow slight axial movement of shaft 422 caused by spring 444.

The spring 444 applies a force to sealing element 430 so that annular rings 436 are kept in constant contact with sealing surface 415 of end plate 414. An o-ring 456 provides a seal between end plate 414 and housing 410 to prevent leakage of the first medium from passageway 412.

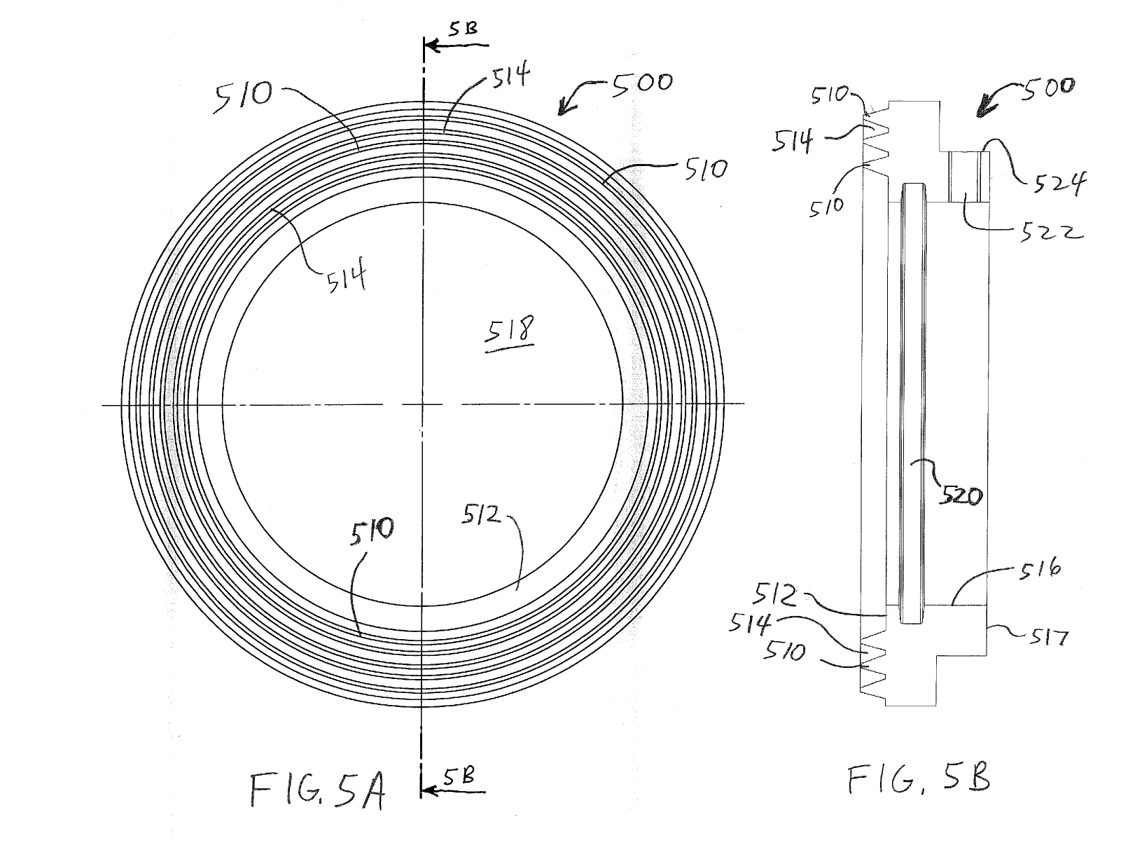

FIGS. 5A and 5B illustrate an annular plate 500 in further detail for a mechanical seal assembly according to an exemplary embodiment. The annular plate 500 is particularly suited for the mechanical seal assemblies 100 and 200 described previously.

The annular plate 500 includes a plurality of annular rings 510 that protrude from a front surface 512 of annular plate 500. One or more cavities 514 can be defined between annular rings 510 for holding a lubricant. Although three annular rings are shown, it should be understood that annular plate 500 can include more or less rings depending on the desired sealing application.

The annular plate 500 has an interior surface 516 between front surface 512 and an opposing back surface 517, with interior surface 516 defining a shaft opening 518 that is sized so that a rotating shaft such as used in a rotary sputter cathode can be fitted therethrough. An annular groove 520 is located for example along interior surface 516 for holding a sealing member such as on o-ring in place against the rotating shaft. An aperture 522 is located in a back portion 524 of annular plate 500 and is in communication with shaft opening 518. The aperture 522 is configured to hold a set screw, a pin, or the like against the rotating shaft, which causes the annular plate 500 to rotate with the shaft.

In an alternative embodiment, annular plate 500 can be formed as an integral portion of a rotatable shaft, such as shown in the embodiment of FIG. 4B.

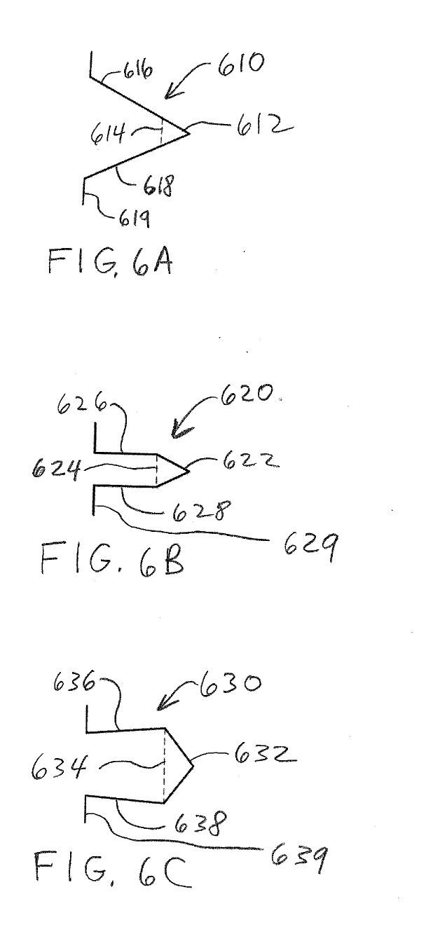

FIGS. 6A-6C illustrate exemplary ring edge geometries for the annular rings of an annular plate of a mechanical seal assembly such as described previously. Depending on the application, there are a variety of edge geometries that can be employed. For example, FIG. 6A depicts a cone shaped edge geometry 610, which can have a sharp edge 612, or a flat edge 614 (dotted line). The cone shaped edge geometry 610 has opposing sides 616 and 618 that taper outwardly to a surface 619 of an annular plate.

FIG. 6B shows a rectangular rib shaped edge geometry 620, which can have a sharp edge 622, or a flat edge 624 (dotted line). The rectangular rib shaped edge geometry 620 has opposing sides 626 and 628 that are substantially perpendicular to a surface 629 of an annular plate.

FIG. 6C illustrates a diamond rib shaped edge geometry 630, which can have a sharp edge 632, or a flat edge 634 (dotted line). The diamond rib shaped edge geometry 630 has opposing sides 636 and 638 that taper inwardly to a surface 639 of an annular plate. With edge geometry 630, a constant contact surface area is maintained after sharp edge 632 wears down. The inwardly tapered sides allow the seal assembly to be easily taken apart, and eliminate friction on the sides as a shaft rotates.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A mechanical seal assembly, comprising:
a first sealing element configured to surround a rotatable shaft, the first sealing element including an annular plate, and a plurality of annular rings that protrude from the annular plate in a direction substantially parallel to the rotatable shaft, the annular rings being concentric with the rotatable shaft;
a second sealing element configured to surround the rotatable shaft, the second sealing element including one or more springs that provide a biasing force against the first sealing element such that substantially constant contact is maintained between the annular rings and a sealing surface; and
one or more lubricant cavities defined between the annular rings and the sealing surface.

2. The mechanical seal assembly of claim 1, further comprising a housing having an interior surface that defines a passageway for the rotatable shaft.

3. The mechanical seal assembly of claim 2, further comprising a seal end plate affixed to the housing and at least partially covering the passageway.

4. The mechanical seal assembly of claim 3, wherein the first sealing element is mounted on the rotatable shaft such that the first sealing element rotates with the rotatable shaft.

5. The mechanical seal assembly of claim 4, wherein the second sealing element is rotationally stationary with respect to the rotatable shaft and the first sealing element, and is axially movable.

6. The mechanical seal assembly of claim 4, wherein the second sealing element further comprises one or more pins surrounding the rotatable shaft and affixed to the seal end plate, thereby preventing the second sealing element from rotating along with the first sealing element, each of the pins holding a corresponding one of the springs in place.

7. The mechanical seal assembly of claim 3, wherein the seal end plate has a passageway through which the rotatable shaft protrudes.

8. The mechanical seal assembly of claim 1, wherein the sealing surface is on the second sealing element.

9. The mechanical seal assembly of claim 2, wherein the housing has a feed thru channel that provides fluid communication from the passageway to outside of the housing.

10. The mechanical seal assembly of claim 9, wherein the rotatable shaft has a channel in fluid communication with the passageway in the housing.

11. The mechanical seal assembly of claim 2, wherein the passageway in the housing has a first compartment that contains a first medium and a second compartment that contains a second medium, the first and second compartments sealingly separated by the first and second sealing elements.

12. The mechanical seal assembly of claim 3, wherein the sealing surface comprises a portion of an inner surface of the seal end plate that faces the passageway.

13. The mechanical seal assembly of claim 12, wherein the second sealing element is mounted on the rotatable shaft so that the second sealing element rotates with the rotatable shaft.

14. The mechanical seal assembly of claim 13, wherein the first sealing element is connected to the second sealing element such that the first sealing element rotates with the rotatable shaft while being axially movable.

15. The mechanical seal assembly of claim 1, wherein the annular plate is an integral portion of the rotatable shaft.

16. The mechanical seal assembly of claim 15, wherein the second sealing element includes a bearing component surrounding the rotatable shaft.

17. An annular plate for a mechanical seal assembly, the annular plate comprising:
a front surface and an opposing back surface;
an interior surface between the front surface and the back surface, the interior surface defining an opening for a rotatable shaft;
a plurality of annular rings that protrude from the front surface of the annular plate; and
one or more cavities between the annular rings for holding a lubricant.

18. The annular plate of claim 17, wherein the annular plate is an integral portion of the rotatable shaft.

19. The annular plate of claim 17, wherein the annular rings have a geometry comprising a cone shaped edge, a rectangular rib shaped edge, or a diamond rib shaped edge.

20. A method of sealing a rotatable shaft, the method comprising:
providing a housing having an interior surface that defines a passageway containing the rotatable shaft;
providing a first sealing element around the rotatable shaft, the first sealing element including an annular plate, and a plurality of annular rings that protrude from the annular plate in a direction substantially parallel to the rotatable shaft, the annular rings being concentric with the rotatable shaft and defining one or more cavities that hold a lubricant; and
positioning a second sealing element around the rotatable shaft, the second sealing element comprising one or more springs that provide a biasing force against the first sealing element such that substantially constant contact is maintained between the annular rings and a sealing surface.
